(19) United States
(12) Patent Application Publication
(10) Pub. No.: US 2026/0046948 A1
(43) Pub. Date: Feb. 12, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: YUKI YOSHIKAWA, Kanagawa (JP)

(21) Appl. No.: 19/361,827

(22) Filed: Oct. 17, 2025

Related U.S. Application Data
(63) Continuation of application No. PCT/JP2024/014986, filed on Apr. 15, 2024.

(30) Foreign Application Priority Data
Apr. 19, 2023 (JP) 2023-068891

(51) Int. Cl. H04W 76/11; H04W 76/30

(52) U.S. Cl. CPC H04W 76/11; H04W 76/30

(57) ABSTRACT

A communication apparatus includes an establishment unit configured to establish a connection with another communication apparatus, an assignment unit configured to assign identification information for identifying the other communication apparatus to the other communication apparatus with which the connection is established, and a sharing unit configured to share the identification information with an external access point, wherein, based on the sharing of the identification information with the communication apparatus, the external access point manages the other communication apparatus and the identification information in association with each other.

### CROSS-REFERENCE TO RELATED APPLICATIONS

This application is a Continuation of International Patent Application No. PCT/JP2024/014986, filed Apr. 15, 2024, which claims the benefit of Japanese Patent Application No. 2023-068891, filed Apr. 19, 2023, both of which are hereby incorporated by reference herein in their entirety.

### BACKGROUND

### Field of the Technology

The present disclosure relates to a communication apparatus compliant with Institute of Electrical and Electronics Engineers (IEEE) 802.11.

### Description of the Related Art

With an increase in the amount of data to be communicated in recent years, a communication technique using a wireless local area network (LAN) or the like is developed. As a major communication standard using a wireless LAN, the Institute of Electrical and Electronics Engineers (IEEE) 802.11 standard series is known. The IEEE 802.11 standard series includes standards such as IEEE 802.11a/b/g/n/ac/ax/be and the like (the publication of Japanese Patent Laid-Open No. 2018-50133).

In the IEEE 802.11be standard, for example, multi-link communication is considered in which a single access point (AP) establishes a plurality of links with a single station (STA) via a plurality of different frequency channels and communicates with the STA in parallel. As the two or more links, two or more links may be selected from the same frequency bands (any of the 2.4 GHz band, the 3.6 GHz band, the 4.9 and 5 GHz band, and the 6 GHz band), or may be selected from different frequency bands. An AP and an STA compatible with multi-links are referred to as an “AP multi-link device (MLD)” and an “STA MLD (or non-AP-MLD)”, respectively.

Conventionally, an association identifier (AID) that is an identifier for identifying an STA is known. The “AID” refers to the identifier of the STA and refers to an identifier assigned to the STA by an AP when the STA and the AP establish a connection.

Incidentally, in the IEEE 802.11be standard and the succession standards of the IEEE 802.11be standard, an improvement in the mobility of communication by causing a plurality of physically different APs to collaboratively operate is considered. At this time, it is possible that a communication procedure formulated by the multi-link function is used as a procedure for establishing links between the two or more physically different APs and an STA and a mechanism for controlling communication. Specifically, it is possible that a plurality of APs is caused to cooperate by sharing a logically single upper MAC layer, thereby improving usability.

However, conventionally, when a plurality of physically different APs is caused to cooperate to operate as a logically single AP MLD, it is not considered how to handle an AID for a predetermined STA in the AP MLD.

### SUMMARY

The present embodiment is made in view of at least one of the above issues. One aspect of the present disclosure is directed to providing a mechanism for appropriately processing identification information for identifying a predetermined STA in two or more physically different APs. Another aspect of the present disclosure is directed to improving the efficiency of processing when a single STA switches a connection destination in two or more physically different APs.

According to an aspect of the present disclosure, a communication apparatus includes an establishment unit configured to establish a connection with another communication apparatus, an assignment unit configured to assign identification information for identifying the other communication apparatus to the other communication apparatus with which the connection is established, and a sharing unit configured to share the identification information with an external access point, wherein, based on the sharing of the identification information with the communication apparatus, the external access point manages the other communication apparatus and the identification information in association with each other.

Features of the present disclosure will become apparent from the following description of embodiments with reference to the attached drawings.

### BRIEF DESCRIPTION OF THE DRAWINGS

FIG. 1 is a diagram illustrating an example of a configuration of a network according to the present disclosure.

FIG. 2 is a diagram illustrating an example of a hardware configuration of each of access points (APs) and a station (STA) according to the present disclosure.

FIG. 3 is a diagram illustrating an example of a functional configuration of each of the APs and the STA according to the present disclosure.

FIG. 4 is a flowchart of a connection process according to a first embodiment.

FIG. 5 is an example of a sequence according to the first embodiment.

FIG. 6 is an example of a sequence according to the first embodiment.

FIG. 7 is an example of a configuration of a multi-link element according to the present disclosure.

FIG. 8 is a flowchart of a connection process according to a second embodiment.

FIG. 9 is an example of a sequence according to the second embodiment.

FIG. 10 is the example of the sequence according to the second embodiment.

FIG. 11 is an example of a sequence according to the second embodiment.

### DESCRIPTION OF THE EMBODIMENTS

With reference to the attached drawings, embodiments of the present disclosure will be described in detail below. The configurations illustrated in the following embodiments are merely examples, and the present disclosure is not limited to the configurations illustrated in the figures.

### (Configuration of Wireless Communication System)

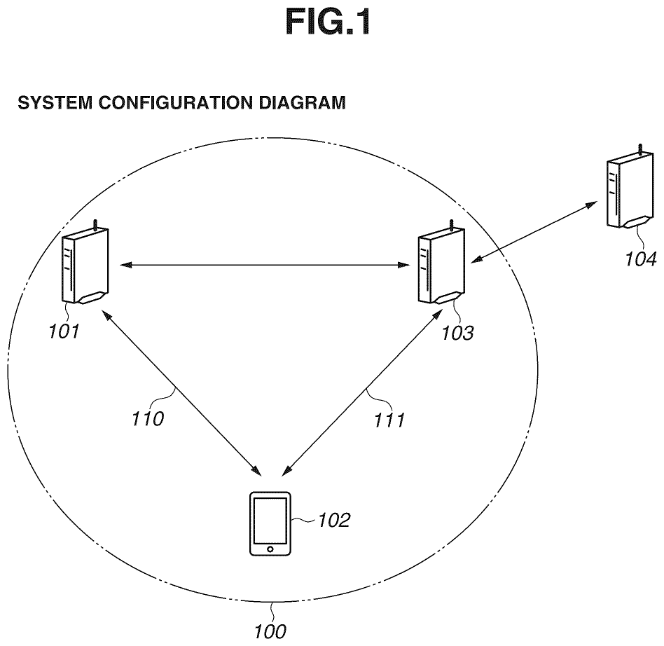

FIG. 1 illustrates an example of the configuration of a network according to the present embodiment. FIG. 1 illustrates a configuration in which a station (STA) 102 (a terminal) participates in a network 100 constructed by a certain access point (AP) 101 (a base station). The AP 101, an AP 103, and an AP 104 cooperate to logically function as a single AP multi-link device (MLD). More specifically, the APs 101, 103, and 104 collaborate to provide a function as, at least logically, a single upper medium access control (MAC) layer. The APs 101, 103, and 104 also function as a single AP MLD by causing functions as lower MAC layers included in the APs 101, 103, and 104 and the function as the logically single upper MAC layer to collaborate. This means that three physically different APs are caused to function as a single AP MLD in relation to an STA. Hereinafter, the provision of a function as a logically single upper MAC layer by a plurality of APs is also referred to simply as “the sharing of an upper MAC layer”.

Although in the present embodiment, an example has been illustrated where a logically identical single AP MLD is formed by causing a plurality of APs to cooperate to share an upper MAC layer, the method for sharing an upper MAC layer is not limited to this. For example, a configuration can also be employed in which a function as a superordinate controller for serving as an AP MLD is provided outside, whereby the plurality of APs and the superordinate controller are caused to collaborate to share an upper MAC layer. Alternatively, a configuration can also be employed in which some functions as the superordinate controller are provided on a cloud server (not illustrated), and the functions that operate on the cloud server and functions provided by the APs are caused to collaborate, thereby achieving a logically single upper MAC layer.

In the example of the configuration of the network, the STA 102 can transmit and receive signals transmitted to and received from the APs 101 and 103. The AP 101 can directly transmit and receive signals to and from the AP 103. The AP 103 can directly transmit and receive signals to and from the APs 101 and 104. The AP 104 can directly transmit and receive signals to and from the AP 103. The APs 101, 103, and 104 may directly communicate with each other, or communicate with each other via a server that provides the function as the superordinate controller or via a communication apparatus that provides the function as the cloud server. Although in the example of the configuration of the network, an example has been illustrated where the APs 101, 103, and 104 wirelessly communicate with each other, the present disclosure is not limited to this. For example, the APs 101, 103, and 104 may be configured to directly communicate with each other via Ethernet or cables for wired connections such as optical fibers or the like.

The AP 101 and the STA 102, the AP 103, and the AP 104 are configured to be able to communicate a wireless frame compliant with a succession standard aimed at improving reliability and accomplishing low latency that is a succession standard of Institute of Electrical and Electronics Engineers (IEEE) 802.11be. Similarly, the STA 102 is also configured to be able to communicate a wireless frame compliant with the succession standard. IEEE is the abbreviation of Institute of Electrical and Electronics Engineers. Based on the above, in the present embodiment, the succession standard aimed at improving reliability and accomplishing low latency that is a succession standard of IEEE 802.11be is referred to also as “IEEE 802.11bn” or “IEEE 802.11 Ultra High Reliability (UHR)”. A wireless frame communicated based on the succession standard is referred to also as “UHR PPDU”. PPDU is the abbreviation of PLCP Protocol Data Unit. PLCP is the abbreviation of Physical Layer Convergence Protocol.

The names “IEEE 802.11bn”, “IEEE 802.11UHR”, and “UHR standard” are provided for convenience based on a target that should be achieved by the succession standard or the main feature of the standard. Thus, these names can be other names in the state where the formulation of the standard is completed. On the other hand, it may be noted that the specification and the appended claims are essentially applicable to the succession standards of the 802.11be standard and all the succession standards.

Each communication apparatus can communicate in frequency bands such as the 2.4 GHz band, the 3.6 GHz band, the 5 GHz band, and the 6 GHz band, and the 45 GHz band and the 60 GHz band termed millimeter-wave bands. The frequency bands used by each communication apparatus are not limited to these, and a different frequency band such as the Sub-1 GHz band may be used. Each communication apparatus can communicate using 20 MHz, 40 MHz, 80 MHz, 160 MHZ, 320 MHz, 540 MHz, 640 MHz, 1080 MHz, and 2160 MHz bandwidths. The bandwidths used by each communication apparatus are not limited to these, and a different bandwidth such as a 240 MHz or 4 MHz bandwidth may be used.

Although the AP 101, the STA 102, the AP 103, and the AP 104 are compatible with the IEEE 802.11UHR standard, in addition to this, the AP 101, the STA 102, the AP 103, and the AP 104 may be compatible with legacy standards that are standards before the IEEE 802.11UHR standard. Specifically, the AP 101, the STA 102, the AP 103, and the AP 104 may be compatible with at least any one of the IEEE 802.11a/b/g/n/ac/ax/be standards. In addition to the IEEE 802.11 series standards, the AP 101, the STA 102, the AP 103, and the AP 104 may also be compatible with another communication standard such as Bluetooth®, near-field communication (NFC), ultra-wideband (UWB), Zigbee, MultiBand OFDM Alliance (MBOA), or the like. UWB is the abbreviation of ultra-wideband. MBOA is the abbreviation of MultiBand OFDM Alliance. NFC is the abbreviation of near-field communication. UWB includes Wireless Universal Serial Bus (USB), Wireless 1394, WiNET, and the like. The AP 101, the STA 102, the AP 103, and the AP 104 may also be compatible with a wired communication standard for a wired local area network (LAN) or the like. Specific examples of the APs 101, 103, and 104 include a wireless LAN router, a personal computer (PC), and the like. The present disclosure, however, is not limited to these. Alternatively, the AP 101 may be an information processing apparatus such as a wireless chip capable of executing wireless communication compliant with the IEEE 802.11UHR standard or the like. Specific examples of the STA 102 include a camera, a tablet, a smartphone, a PC, a mobile phone, a video camera, a headset, a network camera, a printer, a projector, and the like. The present disclosure, however, is not limited to these. Alternatively, the STA 102 may be an information processing apparatus such as a wireless chip capable of executing wireless communication compliant with the IEEE 802.11UHR standard or the like.

The AP 101 and the STA 102, the AP 103, and the AP 104 execute multi-link communication in which the AP 101 and the STA 102, the AP 103, and the AP 104 establish a plurality of links via a plurality of frequency channels and communicate with each other. An AP capable of executing multi-link communication is referred to also as an “AP MLD”. For example, the AP 101 can establish a link 110 via a first frequency channel in the 5 GHz band with the STA 102 and communicate with the STA 102. The STA 102 can establish a link 111 via a second frequency channel in the 6 GHz band with the AP 103 in parallel with the link 110 and communicate with the AP 103. At this time, the APs 101 and 103 cooperate to form an AP MLD. Thus, the STA 102 can execute multi-link communication in which the second link 111 via the second frequency channel is maintained in parallel with the link 110 via the first frequency channel. As described above, the APs 101 and 103 establish links via a plurality of frequency channels with the STA 102, whereby it is possible to improve the throughput in communication between the APs 101 and 103 and the STA 102.

As a link between communication devices, a plurality of links different from each other in frequency band may be established in multi-link communication. For example, the STA 102 may establish a third link in the 2.4 GHz band with the AP 101 in addition to the link 110 in the 5 GHz band with the AP 101 and the link 111 in the 6 GHz band with the AP 103. Alternatively, links may be established via a plurality of different channels included in the same frequency band. For example, the STA 102 may establish channel 36 in the 5 GHz band as a first link with the AP 101, and in addition to this, may establish channel 161 in the 5 GHz band as a second link with the AP 103. Links may be established so that links in the same frequency band and links in different frequency bands may coexist. For example, the STA 102 may establish a link via channel 35 in the 6 GHz band with the AP 101 and a link via channel 6 in the 2.4 GHz band with the AP 103 in addition to the link 110 via channel 2 in the 6 GHz band with the AP 101. The AP 101 establishes a plurality of connections at different frequencies with the STA 102, whereby, even if a certain band is congested, the AP 101 can establish communication with the STA 102 in another band. Thus, the AP 101 can prevent a decrease in the throughput and a communication delay in communication with the STA 102.

To each link, a link identifier (ID) is assigned with respect to each network constructing the link. For example, a case is considered where the STA 102 participates in a network in the 5 GHz band among networks constructed by the APs 101, 103, and 104. To the link 110 constructed via channel 36 in the 5 GHz band with the AP 101 by the STA 102, a link ID=1 is assigned. Similarly, since a link ID is common to each network, if an STA different from the STA 102 establishes a link via channel 36 in the 5 GHz band with the AP 101, the link ID of the link is 1. To the link 111 constructed by the STA 102 participating in a network in the 6 GHz band, a link ID=2 is assigned. These values are merely examples, and other values may be assigned to the respective links, or a link ID may be assigned with respect to each constructed link or each STA.

The IEEE 802.11 series standards define the bandwidths of frequency channels in the 2.4 GHz band, the 5 GHz band, and the 6 GHz band as 20 MHz. The IEEE 802.11 series standards also define the bandwidths of frequency channels in the 45 GHz band as 540 MHz and the bandwidths of frequency channels in the 60 GHz band as 1080 MHz or 2160 MHz. The “frequency channels” refer to frequency channels defined by the IEEE 802.11 series standards, and a plurality of frequency channels is defined in frequency bands such as the 2.4 GHz band, the 5 GHz band, the 6 GHz band, the 45 GHz band, and the 60 GHz band. A bandwidth of 40 MHz or more may be used in a single frequency channel by bonding a frequency channel and an adjacent frequency channel.

### (Configurations of APs and STA)

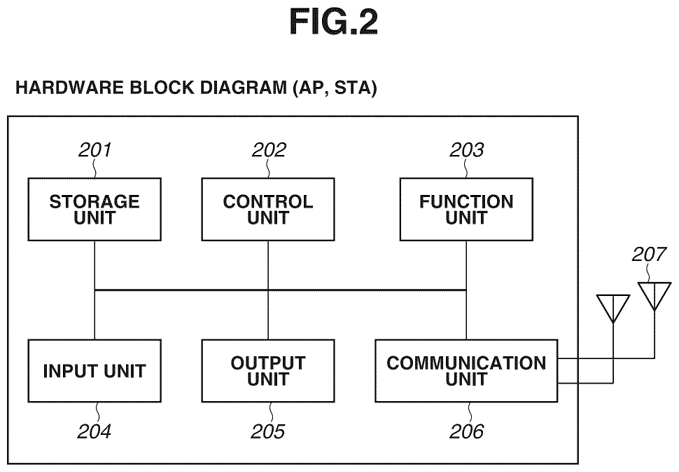

FIG. 2 illustrates an example of the hardware configuration of the AP 101 according to the present embodiment. The AP 101 includes a storage unit 201, a control unit 202, a function unit 203, an input unit 204, an output unit 205, a communication unit 206, and an antenna 207. The AP 101 may include a plurality of antennas.

The storage unit 201 includes one or more memories such as a read-only memory (ROM), a random-access memory (RAM), and the like and stores computer programs for performing various operations described below, and various types of information such as communication parameters for wireless communication and the like. ROM is the abbreviation of read-only memory. RAM is the abbreviation of random-access memory. As the storage unit 201, in addition to the memories such as the ROM, the RAM, and the like, a storage medium such as a flexible disk, a hard disk, an optical disc, a magneto-optical disc, a Compact Disc Read-only Memory (CD-ROM), a Compact Disc Recordable (CD-R), a magnetic tape, a non-volatile memory card, a digital versatile disc (DVD), or the like may be used. Alternatively, the storage unit 201 may include a plurality of memories or the like.

The control unit 202 includes one or more processors such as a central processing unit (CPU), a microprocessor unit (MPU), and the like and controls the entirety of the AP 101 by executing a computer program stored in the storage unit 201. The control unit 202 may collaborate with the computer program and an operating system (OS) stored in the storage unit 201 to control the entirety of the AP 101. The control unit 202 also generates data and a signal (a wireless frame) to be transmitted through communication with another communication apparatus. CPU is the abbreviation of central processing unit. MPU is the abbreviation of microprocessor unit. Alternatively, the control unit 202 may include a plurality of processors such as multi-core processors and the like and control the entirety of the AP 101 using the plurality of processors.

The control unit 202 also controls the function unit 203 to execute a predetermined process such as wireless communication, the capturing of an image, printing, projection, or the like. The function unit 203 is hardware for the AP 101 to execute the predetermined process.

The input unit 204 receives various operations from a user. The output unit 205 provides various outputs to the user through a monitor screen or a loudspeaker. The outputs provided by the output unit 205 may be display on the monitor screen, the output of a sound from the loudspeaker, the output of a vibration, or the like. Both the input unit 204 and the output unit 205 may be achieved by a single module as in a touch panel. Each of the input unit 204 and the output unit 205 may be integrated with or separate from the AP 101.

The communication unit 206 controls wireless communication compatible with the IEEE 802.11UHR standard. In addition to the IEEE 802.11UHR standard, the communication unit 206 may also control wireless communication compatible with another IEEE 802.11 series standard, or control wired communication via a wired LAN or the like. The communication unit 206 controls the antenna 207 to transmit and receive a wireless signal for wireless communication generated by the control unit 202.

In a case where the AP 101 is compatible with the NFC standard, the Bluetooth® standard, or the like in addition to the IEEE 802.11UHR standard, the AP 101 may control wireless communication compliant with these communication standards. In a case where the AP 101 can execute wireless communication compliant with a plurality of communication standards, the AP 101 may individually include a communication unit and an antenna compatible with each communication standard. The AP 101 communicates data such as image data, document data, video data, or the like with the STA 102 via the communication unit 206. The antenna 207 may be configured separately from the communication unit 206, or may be configured together with the communication unit 206 as a single module.

The antenna 207 is an antenna capable of communicating in the 2.4 GHz band, the 5 GHz band, the 6 GHz band, the 45 GHz band, and the 60 GHz band. Although the AP 101 includes two antennas in the present embodiment, the AP 101 may include three antennas. Alternatively, the AP 101 may include a different antenna with respect to each frequency band. In a case where the AP 101 includes a plurality of antennas, the AP 101 may include a communication unit 206 corresponding to each antenna. Each of the STA 102, the AP 103, and the AP 104 has a hardware configuration similar to that of the AP 101.

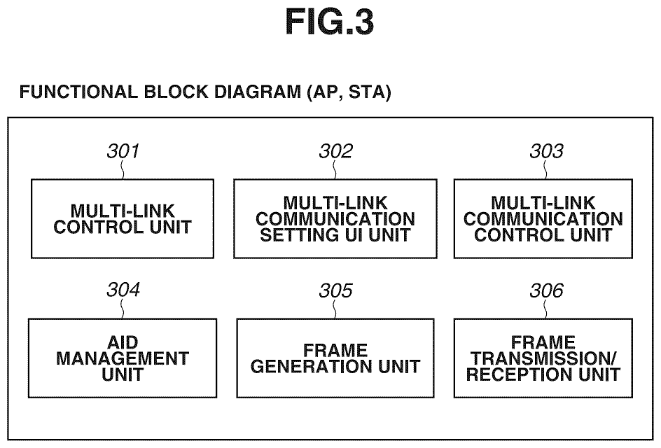

FIG. 3 illustrates a block diagram of the functional configuration of the AP 101 according to the present embodiment. In the present embodiment, the functional blocks are stored as programs in the storage unit 201. The functions of the functional blocks are performed by the control unit 202 executing the programs. The control unit 202 achieves the functions by controlling pieces of hardware and calculating and processing information by executing the programs. Part or all of the functional blocks may be achieved as hardware. In this case, a part or all of each functional block is configured by, for example, an application-specific integrated circuit (ASIC). Each of the AP 103, the AP 104, and the STA 102 also has a similar configuration.

In the present embodiment, the AP 101 includes a multi-link control unit 301, a multi-link communication setting user interface (UI) unit 302, a multi-link communication control unit 303, an association identifier (AID) management unit 304, a frame generation unit 305, and a frame transmission/reception unit 306.

The multi-link control unit 301 is a block that controls a communication start process for the AP 101 to establish one or more links to be used for wireless communication with the STA 102, an addition process and a deletion process on a link after the communication is started, and a communication end process for deleting all the links. Specifically, a connection process includes an authentication process, an association process, and a 4-way-handshake (4WHS) process.

The multi-link communication setting UI unit 302 provides a UI for the user to input the setting of multi-link communication of the AP 101 through an operation screen of the AP 101. The multi-link communication setting UI unit 302 may receive an input provided by the user on a display unit included in an apparatus separate from the AP 101. For example, the multi-link communication setting UI unit 302 may be configured to display the UI on another communication apparatus that cooperates with the AP 101, such as a server, another AP, a PC, or the like. In this case, the multi-link communication setting UI unit 302 receives the setting based on a user operation on an input unit of the separate apparatus.

The multi-link communication control unit 303 manages the state where the AP 101 is connected as an AP MLD to an STA MLD in a case where the AP 101 communicates via a link established by the multi-link control unit 301. For example, in this state, even if a link is not established with the STA 102 by the AP 101, but if a link is established with the STA 102 by the AP 103, the AP 101 is connected as an AP MLD to the STA 102. Whether the AP 101 is connected to or disconnected from the STA 102 is managed based on communication between the APs 101 and 103 and communication between the AP 101 and the STA 102. The multi-link communication control unit 303 can also function to manage a connection to and a disconnection from the STA 102 regarding a single link.

The AID management unit 304 manages an AID that is an identifier identifying a counterpart STA with which a connection is established by the AP 101. When the multi-link control unit 301 performs a connection process, the AID management unit 304 manages AIDs to be assigned to STAs as counterparts of the connection process with respect to each STA. Then, the AID management unit 304 holds an AID regarding an STA with which a connection state is maintained in the multi-link communication control unit 303. If the connection relationship with a predetermined STA enters a disconnection state, the AID management unit 304 cancels a held AID regarding the STA.

The frame generation unit 305 is a block that generates a frame for exchanging frames when the AP 101 communicates with an STA as a connection destination or another AP near the AP 101.

The frame transmission/reception unit 306 transmits wireless frames including a probe request frame and a data frame generated by the frame generation unit 305 and receives a wireless frame from a counterpart apparatus. The frame transmission/reception unit 306 also refers to operation settings such as parameters for communication and the like saved in the storage unit 201 and performs the process of interpretating the received frame. The frame transmission/reception unit 306 can also be configured to change the operation settings based on a user operation received through the input unit 204. Information regarding a frame generated by the frame generation unit 305 is transmitted to a communication counterpart via the frame transmission/reception unit 306.

### (Flow of Processing)

Next, a description is given of some embodiments of the flow of processing executed by the APs and the STA as described above, a sequence in a wireless communication system, and the like.

### First Embodiment

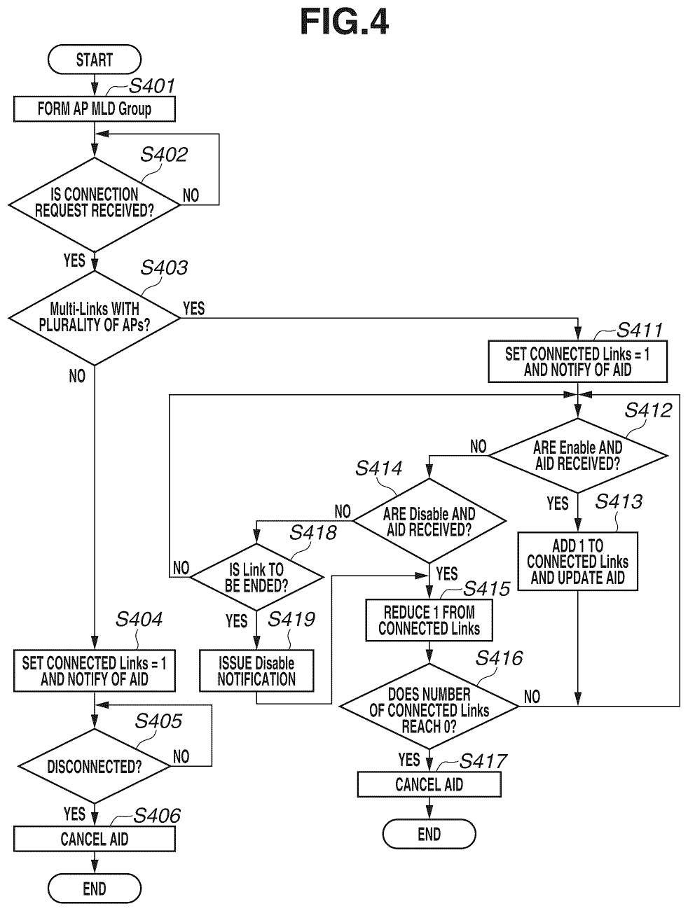

In a first embodiment, with reference to FIG. 4, a description is given of an operation in which the APs 101, 103, and 104 belonging to an AP MLD formed by the APs 101, 103, and 104 collaborating share an AID when the AP 101 and the STA 102 connect to each other. A description is also given of an operation in which the APs 101, 103, and 104 cancel the AID when the connection between the AP 101 and the STA 102 is disconnected. “The cancellation of an AID” means the cancellation of the assignment of an AID assigned once to a communication apparatus. In the present embodiment, it is assumed that processes illustrated in the flowchart in FIG. 4 are achieved by the processors of the control unit 202 of the AP 101 executing programs for achieving control modules. The process of transmitting and receiving data or the like is achieved in collaboration with hardware such as the communication unit 206 or the like. In a case where the subject that performs the processing is to be clarified, the description is given such that a functional unit achieved by the control unit 202 executing a program is the subject. As described above, a part or all of the processing can also be achieved by hardware such as an ASIC, an application-specific standard product (ASSP), a system on a chip (SoC), or the like. ASSP is the abbreviation of application-specific standard product. SoC is the abbreviation of system on a chip.

FIG. 4 illustrates a series of processes in which the AP 101 starts an operation as an AP, connects to the STA 102, and disconnects the connection with the STA 102. This processing is started when the AP 101 starts a function as an AP, such as when the power supply of the AP 101 is turned on, or when the AP 101 receives an instruction to operate as an AP, or when the wireless function of the AP 101 is turned on, or the like. Although in the present embodiment, only the STA 102 is connected, a plurality of STAs may be simultaneously connected.

First, in step S401, the multi-link communication control unit 303 forms a group for forming an AP MLD with other APs. As the method for forming the group at this time, for example, the multi-link communication control unit 303 can inquire of preset destinations about the group and grasp APs included in the group based on a list obtained by the inquiry. Alternatively, the multi-link communication control unit 303 may make a request to a nearby AP, and based on a response to the request, determine whether the AP is to belong to the same AP MLD. Yet alternatively, a configuration can also be employed in which the user is allowed to specify the group for forming the AP MLD using a UI or the like. In this case, the multi-link communication setting UI unit 302 of the AP 101 may display a setting screen for selecting some other APs capable of collaborating with the AP 101 to form the AP MLD. Then, the user may be allowed to select with which of the other APs the AP 101 is to collaborate to form the AP MLD via the setting screen. In this case, a configuration may be employed in which information regarding one or more other APs selected via the setting screen is stored as the preset destinations. The other APs capable of collaborating with the AP 101 to form the AP MLD are not limited to other APs within the range where the AP 101 can directly communicate. For example, in FIG. 1, the APs 101 and 104 cannot directly communicate with each other. However, even in such a case, the APs 101 and 104 can collaborate by communicating with each other via the AP 103 (or the cloud server).

Next, in step S402, the frame transmission/reception unit 306 waits for a connection request from the STA 102. For example, the connection request from the STA 102 is a probe request frame or an association request frame. If the frame transmission/reception unit 306 receives either of these frames (Yes in step S402), then in step S403, the frame transmission/reception unit 306 analyzes the frame. Based on the result of the analysis, the frame transmission/reception unit 306 determines whether the STA 102 is attempting to connect to the AP 101 via a single link or is attempting to connect to the AP MLD to which the AP 101 belongs via multi-links. For example, the determination is made based on whether the received frame includes a multi-link element. Alternatively, for example, the determination may be made based on the value of an “extended” field of the received frame. The multi-link element can include information about other links regarding the AP MLD. For example, information collected in a millimeter-wave band may be assigned to the multi-link element.

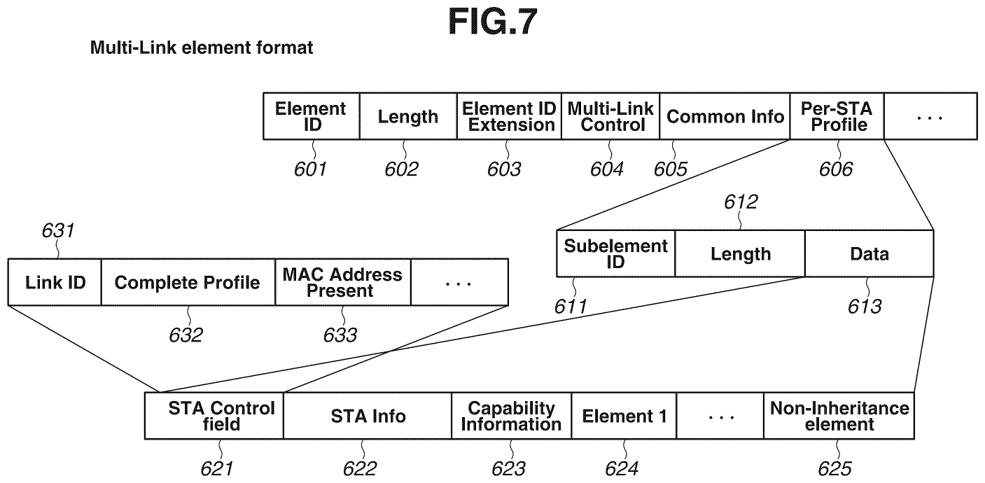

First, with reference to FIG. 7, an example of the configuration of the multi-link element is described.

The multi-link element includes element ID 601, length 602, element ID extension 603, multi-link control 604, common info 605, and per-STA profile 606. In the present embodiment, links-minus-one “per-STA profile” fields 606 are present.

The element ID 601 and the element ID extension 603 indicate that this element is a multi-link element. The length 602 indicates the entire length of the multi-link element.

The multi-link control 604 includes a bitmap indicating what information is included in the “common info” field 605, and a “type” field indicating the type of the multi-link element.

The “common info” field 605 includes information common to established links. Based on the values indicated by the multi-link control 604, it is determined whether an MLD MAC address or the like is included in the multi-link element.

Regarding the per-STA profile 606, based on the type indicated by the “type” field of the multi-link control 604, it is determined whether the “per-STA profile” field 606 is included in the multi-link element.

The per-STA profile 606 includes information regarding each link. The per-STA profile 606 is also composed of subelement ID 611, length 612, and data 613. The data 613 includes the details of the information regarding each link.

The data 613 is composed of an “STA control” field 621, STA info 622, capability information 623, element 1 624, and non-inheritance element 625.

The “STA control” field 621 is composed of link ID 631, complete profile 632, and MAC address present 633. The link ID 631 indicates a link number. For example, in the case of the present embodiment, if the link ID 631 is 1, this indicates the link 110 in FIG. 1. If the link ID 631 is 2, this indicates the link 111 in FIG. 1. At this time, this indicates that the STA 102 identifies which link ID an AP serving as the transmission source of a beacon received by the STA 102 has, and then, the STA 102 connects to a link having the identified link ID. For example, a case is considered where the AP 101 has a link ID=1, the AP 103 has a link ID=2, the AP 104 has a link ID=3, and the STA 102 receives only a beacon transmitted from the AP 101. In this case, a multi-link element of a predetermined frame transmitted from the STA 102 includes only a single “per-STA profile” field 606 in which the link ID 631 is 1. For example, if the STA 102 receives beacons from the APs 101 and 103, a multi-link element of a predetermined frame transmitted from the STA 102 includes two “per-STA profile” fields 606. In this case, the “link ID” fields 631 of the “per-STA profile” fields 606 are 1 and 2.

The complete profile 632 indicates information regarding whether to include all information regarding the link. For example, if the STA 102 makes a reply to a request from the AP 101 for all information regarding the link, the STA 102 sets the complete profile 632 to 1 and includes all information to be included in a beacon to be transmitted via each link in fields following the STA info 622. If a common element is assigned to a plurality of links, the “element 1” field 624 and subsequent fields may be omitted regarding that element. Similarly, a field that does not need to be notified before the connection may be omitted.

If, on the other hand, the STA 102 sets the complete profile 632 to 0, a part or the entirety of the element that is to be included in the “element 1” field 624 may be omitted. A field following the MAC address present 633 indicates what field is additionally present in fields indicated by the “STA info” field 622.

In the present embodiment, a beacon, a probe request, and a probe response are set to the complete profile 632=0. An ML probe request and an ML probe response used in MLD setup are set to the complete profile 632=1. The ML probe request and the ML probe response are communicated to obtain information regarding an AP and an STA in other frequency bands that operate via multi-links. The “complete profile” field 632 may be complete profile requested.

To the fields from the “element 1” field 624 to the “non-inheritance element” field 625, element fields unique to each link are assigned.

The description returns to FIG. 4. In step S403, the frame transmission/reception unit 306 receives from the STA 102 an ML probe request including a multi-link element in which information regarding links is assigned to the “per-STA profile” fields 606. Then, the frame transmission/reception unit 306 analyzes the received ML probe request, thereby acquiring information specific to the links or the link numbers regarding which the STA 102 requests information. The AP 101 also assigns a multi-link element to a frame to be transmitted from the frame transmission/reception unit 306 and thereby can transmit information regarding other links or APs to the STA 102.

For example, an extended multi-link element may be prepared, and only if a field external AP bit in the extended multi-link element is on, it may be determined that an STA is compatible with a connection format in which a plurality of APs achieves an AP MLD. This can clearly indicate whether the STA is compatible with an AP that operates as an AP MLD with a plurality of APs. An STA to connect to an AP can recognize a basic service set (BSS) transition notification received from each AP as a link transition notification, and can also select a link by receiving a beacon from a counterpart AP. The multi-link communication control unit 303 can select the transmission of a frame to the STA based on this.

First, a case is described where the AP 101 and the STA 102 connect to each other via a single link. In step S403, if the STA 102 does not wish to make connections via multi-links with a plurality of APs (No in step S403), then in step S404, the AID management unit 304 sets the number of connected links of the AP 101 to 1 and assigns an AID to the STA 102. Then, the AID management unit 304 notifies the STA 102 and the other APs belonging to the AP MLD of the AID via the frame transmission/reception unit 306. At this time, as the AID to be assigned to the STA 102, an AID that does not overlap an AID managed by the AID management unit 304 of the AP 101 to which the STA 102 is to connect is selected. The AID management unit 304 notifies the STA 102 of the AID using an association response or a reassociation response generated by the frame transmission/reception unit 306. The AP 101 communicates data with the STA 102 using the AID assigned to the STA 102 by the AID management unit 304. If the connection process fails, the AP 101 may refuse to connect to the STA 102. In this case, the AID management unit 304 cancels the AID assigned to the STA 102.

After the connection to the STA 102 is completed, then in step S405, the multi-link communication control unit 303 checks whether the connection with the STA 102 is disconnected. Then, if the multi-link control unit 301 determines that the connection with the STA 102 is disconnected (Yes in step S405), then in step S406, the AID management unit 304 cancels the AID assigned to the STA 102.

Next, a case is described where the STA 102 connects to the AP MLD to which the AP 101 belongs via multi-links. If the STA 102 requests connections via multi-links with a plurality of APs in step S403 (Yes in step S403), then in step S411, the AID management unit 304 sets the number of connected links to 1 and assigns an AID to the STA 102. Then, the AID management unit 304 notifies the STA 102 and the other APs belonging to the AP MLD of the AID via the frame transmission/reception unit 306. At this time, as the AID to be assigned to the STA 102, an AID that does not overlap an AID managed by the AID management unit 304 of each AP belonging to the AP MLD to which the STA 102 is to connect is selected. The AID management unit 304 notifies the STA 102 of the AID using an association response or a reassociation response generated by the frame transmission/reception unit 306. The AP 101 communicates data with the STA 102 using the AID assigned to the STA 102 by the AID management unit 304. If the connection process fails, the AP 101 may refuse to connect to the STA 102. In this case, the AID management unit 304 cancels the AID assigned to the STA 102.

After the connection to the STA 102 is completed, then in step S412, the frame transmission/reception unit 306 checks whether the frame transmission/reception unit 306 has received an enable notification for notifying the AP 101 that a link is added and the AID of the STA 102 from another AP belonging to the AP MLD. If the frame transmission/reception unit 306 has received the AID of the STA 102 with the enable notification in step S412 (Yes in step S412), then in step S413, the frame transmission/reception unit 306 adds 1 to the number of connected links of the STA 102. If the enable notification indicates the addition of a plurality of links, the frame transmission/reception unit 306 adds the number of added links to the number of connected links. At this time, the frame transmission/reception unit 306 may manage via which link the STA 102 is connected. If a notification that the AID is to be updated is received with the enable notification, the AID is updated. The AID is updated in a case where the AID overlaps an AID assigned by another AP. For example, in a case where the AID assigned when the AP 101 connects to the STA 102 is an AID already assigned by the AP 103, the AP 103 notifies the APs that the AID assigned to the STA 102 is to be updated to an AID that does not overlap. Then, the AID management unit 304 of the AP 101 having received the notification updates the assignment of the AID to the STA 102. At this time, the AP 101 or 103 may notify the STA 102 of a new AID.

Additionally, in step S414, the frame transmission/reception unit 306 checks whether the frame transmission/reception unit 306 has received a disable notification for notifying the AP 101 that another AP belonging to the AP MLD has disconnected a link with the STA 102 together with the AID of the STA 102. If the frame transmission/reception unit 306 has received the AID of the STA 102 with the disable notification (Yes in step S414), then in step S415, the frame transmission/reception unit 306 reduces 1 from the number of connected links of the STA 102. If the disable notification indicates the disconnection of a plurality of links, the frame transmission/reception unit 306 reduces the number of disconnected links from the number of links. After the number of disconnected links is reduced from the number of connected links, and if the number of connected links reaches 0, then in step S416, the multi-link control unit 301 determines that the connection between the STA 102 and the AP MLD is disconnected. If the multi-link control unit 301 determines in step S416 that the connection between the STA 102 and the AP MLD is disconnected (Yes in step S416), then in step S417, the AID management unit 304 cancels the AID assigned to the STA 102.

In step S418, the multi-link control unit 301 of the AP 101 also checks whether to disable the link with the STA 102. Possible examples of this case include a case where a legitimate deauthentication frame is received from the STA 102, a case where a frame indicating remove link is received from the STA 102, a case where a disconnection instruction to disconnect the STA 102 is received from the user, a case where a certain time elapses after the communication with the STA 102 or a heartbeat for confirming presence is disrupted, a case where a notification indicating that the link provided by the AP 101 is to be disconnected is received from another AP belonging to the AP MLD, and the like.

If the multi-link control unit 301 disconnects the connection with the STA 102 in step S418 (Yes in step S418), then in step S419, the frame transmission/reception unit 306 transmits a disable notification to the other APs belonging to the AP MLD. If a disable notification is received from another AP belonging to the AP MLD, the flow of step S419 may be omitted. Then, the processing proceeds to step S415. If legitimate deauthentication is received from the STA 102, or if a disconnection instruction to disconnect the STA 102 is received from the user, the processing may proceed to step S417. If a disconnection instruction is received from the user, the frame transmission/reception unit 306 transmits a notification indicating the disconnection of the connection with the STA 102 to the other APs separately from the disable notification.

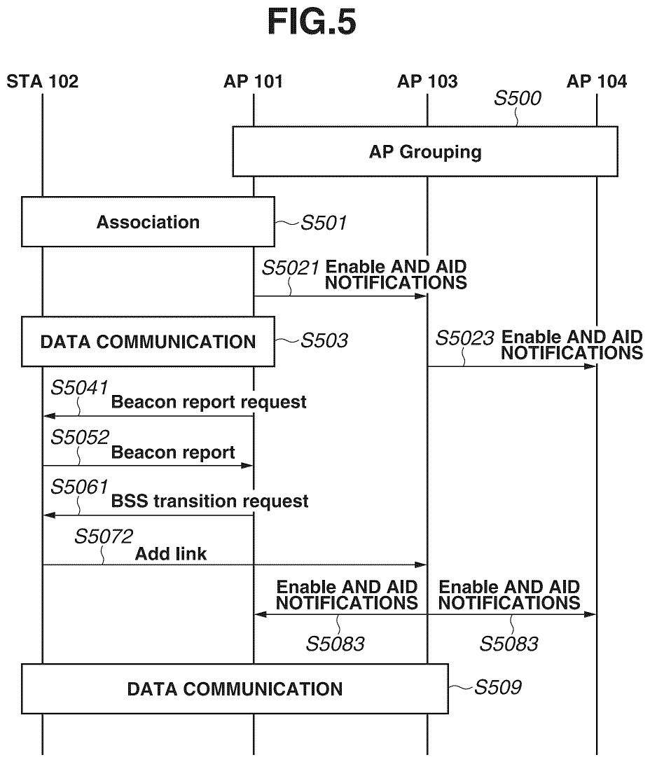

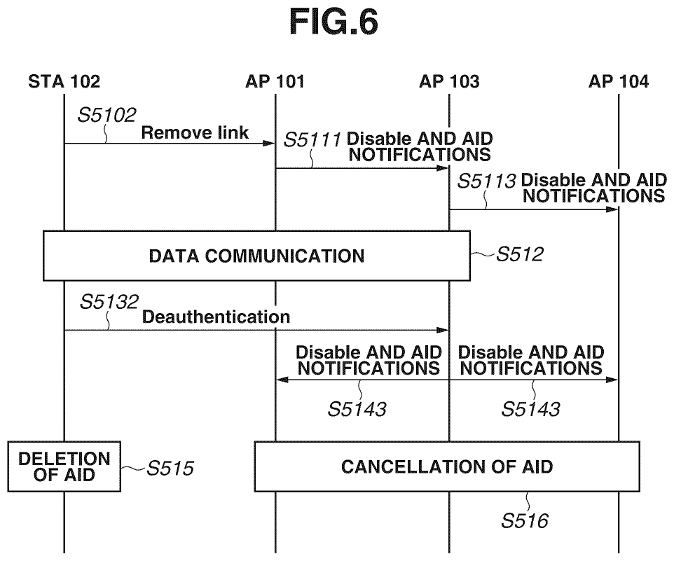

Next, with reference to FIG. 5, a description is given of an example of a sequence in which the AP 101 and the STA 102 start communicating with each other and further connect to the AP 103. With reference to FIG. 6, a description is given of an example of a sequence in which, after the connection of the STA 102 with the AP 103, the AP 101 and the STA 102 disconnect communication, and the AP 103 and the STA 102 also disconnect communication.

First, in step S500, the APs 101, 103, and 104 form an AP MLD based on the process of step S401 in FIG. 4. Then, in step S501, the STA 102 makes a connection request to the AP 101, and the STA 102 and the AP 101 connect to each other via multi-links. At this time, the STA 102 and the AP 101 perform MLD setup in which an ML probe request and an ML probe response are exchanged as connections by the AP MLD. Then, the AP 101 notifies the STA 102 of an AID via association.

If the AP 101 connects to the STA 102, then in step S5021, the frame transmission/reception unit 306 transmits an enable notification with the assigned AID to a nearby AP (the AP 103) to notify the other APs belonging to the AP MLD of the connection. In step S5023, based on the reception of the enable notification from the AP 101, the AP 103 transfers the content of the notification to the AP 104. The transfer and the routing of the notification to be communicated between the APs may be determined when the AP grouping is performed, or all the other APs may be notified by wire. In a case where all the other APs are to be notified by wire, the AP 101 may be configured to hold the addresses of and information regarding all the other APs belonging to the AP MLD and transmit the enable notification to all the other APs.

After the AP 101 and the STA 102 connect to each other, then in step S503, the AP 101 and the STA 102 start communicating with each other based on the assigned AID.

In step S5041, the AP 101 transmits a beacon report request to obtain information regarding an AP near the STA 102. In step S5052, the STA 102 transmits a beacon report as a response to the AP 101. In step S5061, based on information obtained from the STA 102, the AP 101 transmits a BSS transition request to urge also the AP 103 to make a connection. The processes of steps S5041 to S5061 may be omitted.

In step S5072, if the STA 102 confirms that the reception strength of a signal transmitted from the AP 103 is higher than the reception strength of a signal transmitted from the AP 101, the STA 102 transmits an add link request to add a link to the AP 103. The confirmation of the reception strengths may be determined based on beacons transmitted from the APs 101 and 103 or periodic scan. The transmission of the add link request is not limited to this, and the add link request may be transmitted based on the BSS transition request received from the AP 101. The process of step S5072 may be a procedure in which the AP 103 enables a corresponding link ID by TID-to-link mapping, or may be a procedure in which the STA 102 connects to the AP 103 using reassociation. A target to which these signals are transmitted may be the AP 101. Alternatively, the STA 102 may disconnect the connection once to add the AP 103, present links for connecting to the APs 101 and 103 using an ML probe request and a (re) association request, and then reconnect to the APs 101 and 103.

In step S5083, if the AP 103 receives the notification of the addition of a link from the STA 102, first, the AP 103 checks an already assigned AID. If the AP 103 uses an already assigned AID, the AP 103 also notifies the other APs of the AID after an update with an enable notification. Consequently, the APs can grasp the current number of links connected as the AP MLD to the STA 102 and grasp an AID to be used as the AP MLD with respect to each STA. After a link to the AP 103 is added, then in step S509, the STA 102 communicates with the APs 101 and 103 using the common AID in the respective links to the APs 101 and 103.

In step S5102, if the strength of a radio wave received from the AP 101 becomes less than or equal to a threshold, the STA 102 notifies the AP 101 of remove link. This notification may be achieved by transmitting Deauthentication or Disassoc, or may be achieved by not assigning a traffic identifier (TID) to the link ID held in the AP 101 in a TID-to-link mapping request.

In step S5111, based on the reception of the notification of the deletion of the links from the STA 102, the AP 101 transmits a disable notification and the AID of the STA 102 to the nearby AP 103. In step S5113, if the AP 103 receives the disable notification and the AID of the STA 102 from the AP 101, the AP 103 transfers the disable notification and the AID of the STA 102 to the AP 104. After the connection between the AP 101 and the STA 102 is disconnected, then in step S512, the AP 103 and the STA 102 communicate data with each other.

Next, in step S5132, the connection between the AP 103 and the STA 102 is disconnected. In the present embodiment, the STA 102 transmits a disconnection notification to the AP 103. In step S5143, if the disconnection from the STA 102 is confirmed, the AP 103 transmits a disable notification and the AID of the STA 102 to notify the APs 101 and 104 nearby. In step S515, since the STA 102 disconnects the links to all the APs belonging to the AP MLD, the STA 102 deletes the AID assigned by the AP MLD. In step S516, based on the disable notification from the AP 103, the APs 101 and 104 grasp that the links for connecting as the AP MLD to the STA 102 no longer exist. Thus, the APs 101 and 104 cancel the AID at this time. In step S516, based on the disconnection notification from the STA 102, the AP 103 grasps that the links for connecting as the AP MLD to the STA 102 no longer exist. Thus, the AP 103 cancels the AID at this time.

Although in the present embodiment, the processing has been described as each AP holding only a single link, each AP may simultaneously hold a plurality of links. In this case, the number of connections may be increased or decreased according to the number of connected APs, instead of the number of connected links. In this manner, in a case where a plurality of APs forms an AP MLD, the AP 101 can appropriately assign an AID to the STA 102 and appropriately cancel the AID.

### Second Embodiment

In a second embodiment, a case is described where, when the AP 101 and the STA 102 connect to each other, a connection with another AP belonging to an AP MLD is already established by the STA 102, or the STA 102 attempts to also simultaneously establish a connection with another AP. In the present embodiment, it is assumed that processes illustrated in the flowchart in FIG. 4 are achieved by the processors of the control unit 202 of the AP 101 executing programs for achieving control modules. The process of transmitting and receiving data or the like is achieved in collaboration with hardware such as the communication unit 206 or the like. In a case where the subject that performs the processing is to be clarified, the description is given such that a functional unit achieved by the control unit 202 executing a program is the subject. As described above, a part or all of the processing can also be achieved by hardware such as an ASIC, an ASSP, an SoC, or the like.

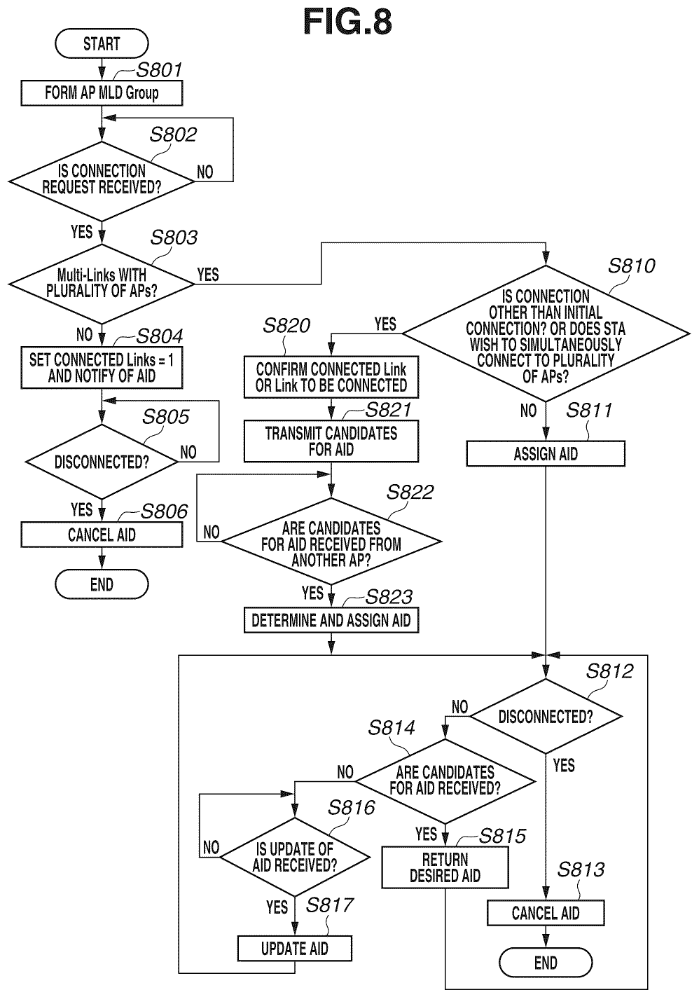

FIG. 8 illustrates a series of processes in which the AP 101 starts an operation as an AP, connects to the STA 102, and disconnects the connection with the STA 102. This processing is started when the AP 101 starts a function as an AP, such as when the power supply of the AP 101 is turned on, or when the AP 101 receives an instruction to operate as an AP, or when the wireless function of the AP 101 is turned on, or the like. The processes of steps S801 to S806 in this flow are equivalent to the processes of steps S401 to S406, and therefore are not described in the present embodiment.

A case is described where, based on the result of the analysis of a connection request frame by the frame transmission/reception unit 306, the frame transmission/reception unit 306 determines that the STA 102 is attempting to connect to the AP MLD to which the AP 101 belongs via multi-links. As a result of the determination in step S803, if the STA 102 requests connections via multi-links with a plurality of APs (Yes in step S803), then in step S810, the AP 101 checks whether the AP 101 has established a connection first as the AP MLD. The determination of whether the AP 101 has established a connection first as the AP MLD is made, for example, based on the type of a frame received from the STA 102 by the frame transmission/reception unit 306. If the type of the frame is an association request, it is determined that this is an initial connection, which is the first connection, as the AP MLD. If the type of the frame is a reassociation request or a TID-to-link mapping request, this connection is treated as an existing connection other than the first connection as the AP MLD. Alternatively, in step S810, the AP 101 checks whether the type of the frame is a connection request in which the STA 102 wishes to simultaneously connect to a plurality of APs and links. The determination is made based on link IDs described in a multi-link element assigned to the association request. Even when the STA 102 wishes to connect to a plurality of links, if all the links are provided by the AP 101, the determination is No in step S810. The two conditions, namely the condition that this connection is other than the initial connection and the condition that the STA 102 wishes to simultaneously connect to a plurality of APs, may be OR conditions. If either of the conditions is satisfied, the determination may be Yes in the process of step S810.

Next, a case is described where the STA 102 wishes to connect to multi-links with a plurality of APs, but an AP to which the STA 102 is to actually connect is only the AP 101, and the STA 102 is not connected to the other APs belonging to the AP MLD (No in step S810). In this case, in step S811, the AID management unit 304 assigns a unique AID to the STA 102 and notifies the STA 102 of the AID via the frame transmission/reception unit 306. On the other hand, a description is given of a case where another AP belonging to the AP MLD is already connected to the STA 102, or a case where the STA 102 wishes to also simultaneously connect to a link provided by an AP other than the AP 101 (Yes in step S810). In this case, first, in step S820, the AP 101 checks the existing link or AP the STA 102 is connected, or which AP other than the AP 101 the STA 102 wishes to simultaneously connect to. Next, in step S821, the frame transmission/reception unit 306 transmits candidates for an AID to be newly assigned by the AP 101 to the target AP. Then, in step S822, the frame transmission/reception unit 306 receives candidates for an AID that can be set for the STA 102 or information regarding an existing AID from the target AP (Yes in step S822). Alternatively, instead of checking which link is connected, the AP 101 may inquire of a device that collectively manages all the APs or AIDs in the AP MLD group about AIDs. In step S823, if the frame transmission/reception unit 306 receives candidates for an AID from the existing AP to which the STA 102 is connected or the AP to which the STA 102 wishes to simultaneously connect, the AID management unit 304 selects an AID that can be assigned from among the candidates, and assigns the selected AID. In the present embodiment, the AP 101 notifies the STA 102 of the AID by transmitting a reassociation response frame to the STA 102 via the frame transmission/reception unit 306. Then, the AP 101 and the STA 102 start communicating with each other using the AID assigned by the AP 101.

Next, a case is described where the connection between the STA 102 and the AP 101 is disconnected (Yes in step S812). Possible examples of this case include a case where all the links to the AP 101 are disabled by deauthentication or TID-to-link mapping from the STA 102, and a case where a disconnection instruction, an instruction to turn off the power supply, or the like given by the user is received through the communication setting UI unit 302. In such a case, in step S813, the AID management unit 304 cancels the AID assigned to the STA 102.

Next, a case is described where the frame transmission/reception unit 306 receives candidates for an AID (step S814 and subsequent steps). After the AP 101 starts communicating with the STA 102, and if the frame transmission/reception unit 306 receives candidates for an AID (Yes in step S814), and if the AP 101 is connected to the STA 102 as the target of the received candidates for an AID, then in step S815, the AID management unit 304 returns AIDs that have not yet been assigned with the AID of the STA 102 as the target to which the AP 101 is connected. Regarding the AIDs to be returned, not all information regarding AIDs that can be returned needs to be transmitted, and information regarding some AIDs may be returned based on priorities from among the AIDs that can be returned. The candidates for an AID received in step S814 are selected similarly to the candidates for an AID transmitted in step S821.

If, on the other hand, the AP 101 is not connected to the target STA, then in step S815, the AP 101 may notify the STA 102 of only an AID that can be assigned by the AP 101. Step S814 may not be a process after the connection, and if the candidates for an AID are received before the AP 101 connects to the STA 102, the AP 101 may respond similarly to the above processing.

After the AP 101 connects to the STA 102, then in step S816, the AP 101 checks whether an update notification of the AID is received. This notification is, when another AP connects to the STA 102 in steps S814 and S815 and in a case where an existing AID cannot be used, a notification issued by another AP to yet another AP different from another AP and already connected to the STA 102. Alternatively, this notification is, when another AP connects to the STA 102 and in a case where the AP 101 is also simultaneously a connection target, a notification issued by the STA 102 to the AP 101. That is, step S816 may not be a process after the connection. That is, the frame transmission/reception unit 306 may receive a notification regarding the update of the AID before the AP 101 connects to the STA 102, and the AID management unit 304 of the AP 101 may record the AID as an AID to be used for communication with the STA 102. A frame received in step S816 is similar to a frame transmitted to the other APs in step S823. If the AP 101 receives an update notification of the AID (Yes in step S816), then in step S817, the AP 101 updates the assignment of the AID to be used for communication with the STA 102.

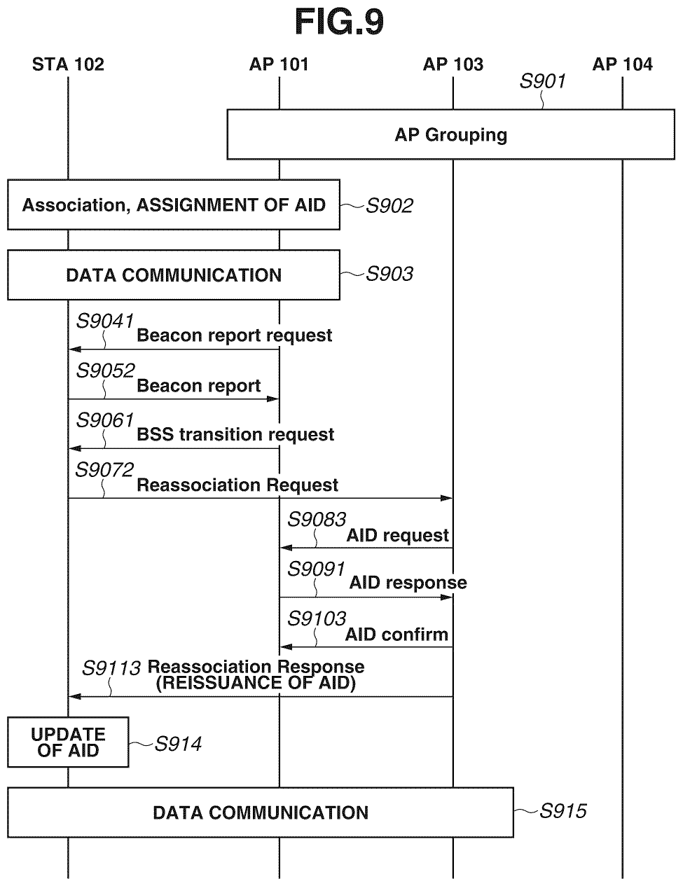

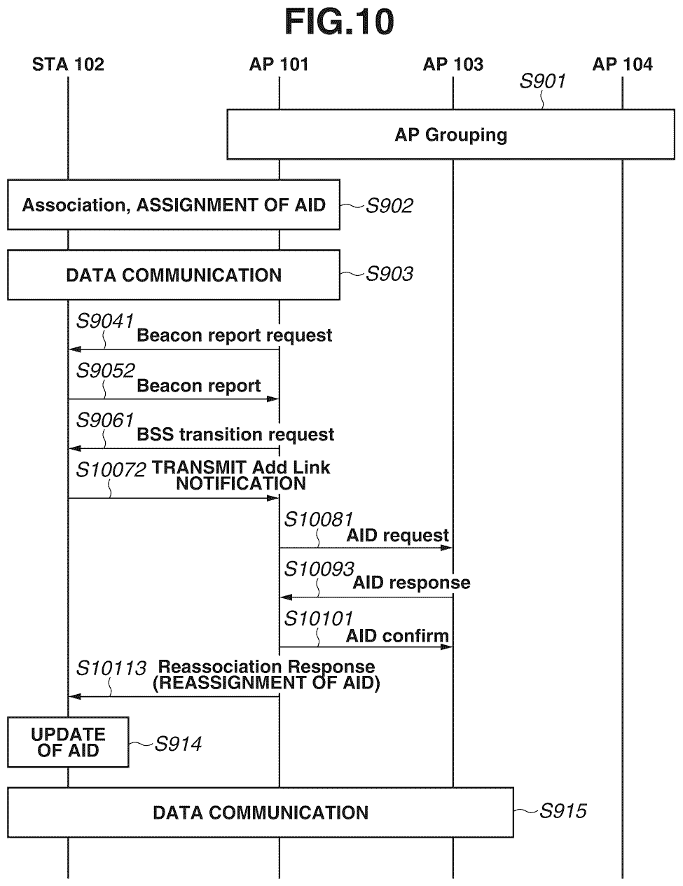

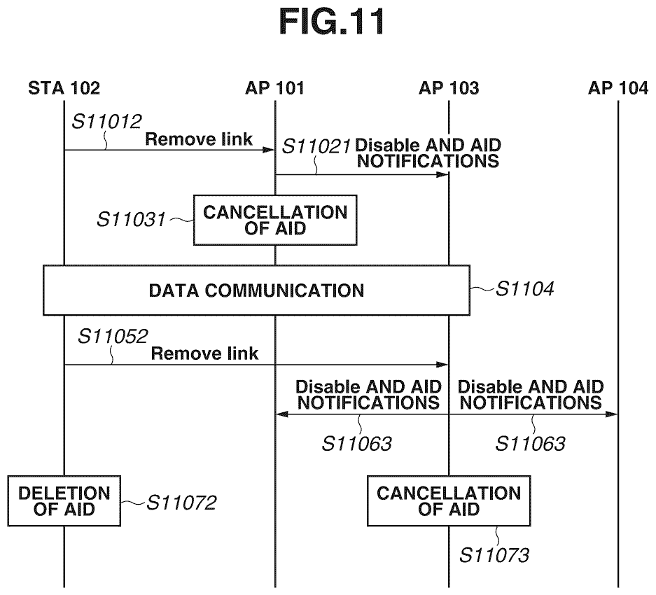

Next, FIGS. 9 and 10 illustrate a sequence in which the AP 101 and the STA 102 start communicating with each other, and further, the AP 103 and the STA 102 connect to each other. Then, FIG. 11 illustrates a sequence in which the AP 101 and the STA 102 disconnect communication, and the AP 103 and the STA 102 also disconnect communication.

First, in step S901, the APs 101, 103, and 104 form an AP MLD group based on the process of step S801 in FIG. 8.

Next, in step S902, the STA 102 makes a connection request to the AP 101, and the STA 102 and the AP 101 connect to each other via multi-links. At this time, the STA 102 and the AP 101 perform MLD setup in which an ML probe request and an ML probe response are exchanged as connections by the MLD, and the AP 101 assigns an AID to the STA 102 using an association response.

After the connection between the AP 101 and the STA 102 is completed, then in step S903, the AP 101 and the STA 102 communicate with each other based on the assigned AID. Steps S9041 to S9061 are similar to steps S5041 to S5061 according to the first embodiment, and therefore are not described.

Next, in step S9072, based on the BSS transition request received from the AP 101, periodic scan, or scan due to a decrease in the reception strength of a beacon from the STA 102, if the STA 102 confirms that the reception strength of a beacon from the AP 103 is higher than the reception strength of a beacon from the AP 101, the STA 102 transmits an add link request to add a link to the AP 103. For example, the process of step S9072 may be a procedure in which the AP 103 enables a corresponding link ID by TID-to-link mapping, or may be a procedure in which the STA 102 connects to the AP 103 using reassociation.

In step S9083, if the AP 103 receives the notification of the addition of a link from the STA 102, the AP 103 analyzes the notification and confirms an AP holding a link to which the STA 102 is currently connected or a link to which the STA 102 wishes to simultaneously connect. Then, the AP 103 transmits an AID request to the AP 101. This is a flow regarding the process of transmitting a frame described with reference to step S821 in FIG. 8. In step S9091, according to the request from the AP 103, the AP 101 returns the AID managed by the AID management unit 304 and assigned to the STA 102 and a list of other AIDs that can be candidates as an AID response. In step S9103, if the AP 103 determines an AID to be assigned to the STA 102, the AP 103 notifies the AP 101 of information regarding the AID as AID confirm. In step S9113, the AP 103 also reassigns an AID to the STA 102 using a reassociation response. In step S914, based on the reassigned AID, the STA 102 updates the AID of the STA 102 to communicate with the APs 101 and 103.

After a link to the AP 103 is added, then in step S915, the STA 102 communicates with the APs 101 and 103 using the common AID via the respective links to the APs 101 and 103. An add link notification from the STA 102 to the AP 103 may be transmitted to the AP 101. With reference to FIG. 10, a sequence in this case is described. The processing up to step S9061 is similar to the above description, and therefore is not described. In step S10072, the STA 102 transmits an add link notification to the AP 101. A frame used for add link is similar to the above description. If the AP 101 receives the add link frame from the STA 102, the AP 101 checks which link the STA 102 is to add. If the STA 102 plans to add another AP, then in step S10081, the AP 101 transmits parameters that include an AID and are being used for the communication with the STA 102 to the AP 103. As the AID to be transmitted, the AID that is being used for the communication with the STA 102 and other candidates for an AID that can be newly assigned and does not overlap another STA may be transmitted together. The parameters to be transmitted are not limited to these, and channel information, information regarding a cryptographic key, and the like may also be transmitted together. If the AP 103 receives the AID and the other candidates, then in step S10093, the AP 103 returns an AID that can be newly assigned to the STA 102 by the AP 103. If the AP 101 determines an AID to be newly assigned, then in step S10101, the AP 101 notifies the AP 103 of the AID. In step S10113, the AP 101 notifies the STA 102 of the reassignment of the AID to be updated, using a reassociation response. After the STA 102 receives the notification of the reassignment, and if the AID needs to be updated, then in step S914, the STA 102 updates the AID. Then, in step S915, the STA 102, the AP 101, and the AP 103 communicate with each other using the common AID for the STA 102.

In step S11012, if the strength of a radio wave of a signal received from the AP 101 becomes less than or equal to a threshold, the STA 102 transmits a notification of remove link to the AP 101. This transmission may be the transmission of deauthentication or disassociation, or may be control for not assigning a TID to the link ID held in the AP 101 in a TID-to-link mapping request.

In step S11021, based on the notification of the deletion of the links received from the STA 102, the AP 101 notifies APs (the APs 103 and 104) near the AP 101 of a disable notification and the AID of the STA 102. Consequently, the APs belonging to the AP MLD can identify an STA to which any of the other APs belonging to the AP MLD is connected. The disable notification in the present embodiment may be omitted. If the AP 101 receives remove link, or if the AP 101 cannot communicate with the STA 102 using a heartbeat for a predetermined time, then in step S11031, the AP 101 determines that the connection with the STA 102 is disconnected. Then, the AP 101 cancels the AID held in the AP 101. If the AP 101 determines that the connection with the STA 102 is disconnected based on a heartbeat, the AP 101 may transmit deauthentication to the STA 102. Alternatively, the AP 101 may confirm that there is no other AP to which the STA 102 is connected, and then transmit deauthentication. If there is no other AP to which the STA 102 is connected, the AP 101 does not transmit deauthentication, thereby preventing the AP MLD and the STA 102 from being unnecessarily disconnected from each other. The AP 101 may inquire of the other APs about connection states to check connections with the STA 102.

After the connection between the AP 101 and the STA 102 is disconnected, then in step S1104, the AP 103 and the STA 102 communicate data with each other. Next, in step S11052, the communication between the AP 103 and the STA 102 is also ended. In the present embodiment, the STA 102 issues a disconnection notification to the AP 103. If the disconnection of the connection with the STA 102 is confirmed, then in step S11063, the AP 103 transmits a disable notification and the AID of the STA 102 to notify the APs 101 and 104 nearby of the disconnection. In step S11072, since the STA 102 disconnects the connections with all the APs belonging to the AP MLD, the STA 102 deletes the AID. In step S11073, according to the disconnection notification from the STA 102, the AP 103 grasps that the links for connecting as the AP MLD to the STA 102 no longer exist. Thus, the AP 103 cancels the AID regarding the STA 102.

In this manner, when the STA 102 makes multi-link connections and in a case where a plurality of APs forms an AP MLD, the AP 101 can appropriately assign and cancel an AID.

As described above, physically different APs forming a logically single AP MLD assign a common AID to a predetermined STA, whereby the physically different APs and the predetermined STA can perform multi-link communication with each other. For example, the APs assign the common AID to the predetermined STA, whereby, when the predetermined STA performs the process of switching a connection from the AP 101 to the AP 103 (roaming), the AP 103 can omit the assignment of an AID to the predetermined STA. Thus, it is possible to improve the efficiency of this switching process.

A case is considered where the STA 102 switches a connection destination from the AP 101 to the AP 103. First, the STA 102 is connected to the AP 101. Next, for example, being triggered by the state where the reception strength of a signal received from the AP 101 by the STA 102 becomes lower than a predetermined threshold, the STA 102 attempts to change the connection destination from the AP 101 to the AP 103. The trigger is not limited to this, and the trigger may be the state where the reception strength of a signal from the AP 101 becomes lower than the reception strength of a signal from the AP 103. At this time, the APs 101 and 103 assign a common AID to the STA 102 and therefore can establish parallel connections (so-called multi-links) with the STA 102. After the STA 102 establishes parallel connections with the APs 101 and 103, the STA 102 disconnects the connection with the AP 101, whereby the switching of the connection destination from the AP 101 to the AP 103 is completed. As described above, the APs 101 and 103 share the AID of the STA 102, whereby the STA 102 can perform roaming utilizing multi-links. Consequently, the STA 102 can switch an AP as a connection destination while maintaining the connection with either of the APs 101 and 103. The advantages of assigning the common AID to the predetermined STA and performing physically different multi-link communications are also noted. The APs can identify the predetermined STA based on the common AID. Thus, it is possible to increase convenience in a case where a plurality of APs is caused to collaboratively operate as an AP MLD. More specifically, in a case where a single AP that operates as an AP MLD issues a trigger frame, the single AP can specify a physically single STA as the destination of the trigger frame based on the common AID. Thus, when the single AP transmits a trigger frame for performing a collaborative operation or a trigger frame for collecting information before a collaborative operation is performed, the single AP only transmits the trigger frame to the common AID as the destination and thereby can give an instruction to a physically single STA MLD. In other words, a certain AP (hereinafter referred to as an “AP 1”) only stores a common AID in an AID 12 subfield of a trigger frame and thereby can give an instruction to a physically single STA MLD using the trigger frame. Specific examples are described. As an example, before the AP 1 performs distributed multiple-input multiple-output (MIMO) communication using a plurality of APs, the AP 1 specifies a common AID for a trigger frame for collecting information at a stage before beam forming is performed. An STA that has received the trigger frame and is identified based on the common AID may be configured to transmit a beam forming report not only to the AP 1 but also to both the AP 1 and an AP 2 with which multi-links are established in response to an instruction given using the trigger frame. As another example, also when the AP 1 instructs the APs 1 and 2 to simultaneously transmit data, the AP 1 can give the instruction by only specifying a common AID as the destination.

### OTHER EMBODIMENTS

Although in the above embodiments, an AP issues a notification to another AP when a link is added or when a link is reduced, for example, the AP may periodically communicate information regarding all STAs to which the AP is connected within an AP MLD, or the AP may communicate only in a case where a change is made and at periodic times.

Although in the above embodiments, the AID management unit 304 manages an STA and the assignment of an AID, the present disclosure is not limited to this. For example, when the AID management unit 304 manages an AID, the AID management unit 304 may manage a Basic Service Set Identifier (BSSID) or a link ID and the AID in association with each other. In such a case, an STA can be identified based on two pieces of information, namely the link ID and the AID, and therefore, it is possible to permit the assignment of either the link ID or the AID to overlap in STAs. Thus, an AP can identify more STAs than in a case where only the AID is assigned.

Although in the above embodiments, APs each manage an AID, a certain single AP may serve to manage an AID. For example, only the AP 101 may manage an AID and APs to which the STA connects, and the other APs may inquire of the AP 101 about a new AID when the STA connects to the other APs. Alternatively, instead of the AP 101, a device that does not directly generate a radio wave may serve to assign an AID.

With reference to FIG. 1, a case is briefly described where, for example, only a single AP manages an AID of an AP MLD Gr. In FIG. 1, the APs 101, 103, and 104 collaborate to form a single AP MLD Gr, and only the AP 103 manages an AID. In this case, when the AP 101 connects to the STA 102, the AP 101 inquires of the AP 103 about an AID of the STA 102. In response to the inquiry from the AP 101, if an AID is already assigned to the STA 102, the AP 103 notifies the AP 101 of the already assigned AID as a response to the inquiry. If an AID has not yet been assigned, the AP 103 may assign an AID to the STA 102 and notify the AP 101 of the assigned AID. Alternatively, a configuration may be employed in which if an AID has not yet been assigned, the AP 103 notifies the AP 101 of candidates for an AID that can be newly assigned, and the AP 101 notifies the AP 103 of an AID assigned to the STA 102 among the candidates for an AID by the AP 101. The AP 103 that manages an AID may be configured to be able to connect to an external STA, or may be configured as an apparatus that does not connect to an external STA and manages an AID.

Also in a case where a device (a server or the like) that does not directly generate a radio wave serves to assign an AID, the device is configured to perform processing similar to that of the AP 103. The device and the APs are connected together by wire and share an AID through communication, for example, based on Gigabit Ethernet (GbE), 10 GbE, or the like compliant with the IEEE standards as Ethernet. The communication method is not limited to these, and may be configured based on interconnect such as InfiniBand or the like, industrial Ethernet, or the like.

In the present disclosure, a storage medium recording a program code of software for achieving the above functions may be supplied to a system or an apparatus, and a computer (a CPU or an MPU) may read and execute the program code stored in the storage medium. In this case, the program code itself read from the storage medium achieves the functions of the above embodiments, and the storage medium storing the program code constitutes the present disclosure.

As the storage medium for supplying the program code, for example, a flexible disk, a hard disk, an optical disc, a magneto-optical disc, a Compact Disc Read-Only Memory (CD-ROM), a Compact Disc-Recordable (CD-R), a magnetic tape, a non-volatile memory card, a ROM, a Digital Versatile Disc (DVD), or the like can be used.

Not only may the above functions be achieved by executing the program code read by the computer, but also the above functions may be achieved by an OS, while operating on the computer, performing a part or all of actual processing based on an instruction from the program code. OS is the abbreviation of operating system.

Further, the program code read from the storage medium may be written into a memory included in a function extension board inserted into the computer or a function extension unit connected to the computer. Then, a CPU included in the function extension board or the function extension unit may perform a part or all of actual processing based on an instruction from the program code, thereby achieving the above functions.

The present disclosure can also be achieved by the process of supplying a program for achieving one or more functions of the above embodiments to a system or an apparatus via a network or a storage medium, and of causing one or more processors of a computer of the system or the apparatus to read and execute the program. The present disclosure can also be achieved by a circuit (e.g., an ASIC) for achieving the one or more functions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
an establishment unit configured to establish a connection with another communication apparatus;
an assignment unit configured to assign identification information for identifying the other communication apparatus to the other communication apparatus with which the connection is established; and
a sharing unit configured to share the identification information with an external access point,
wherein, based on the sharing of the identification information with the communication apparatus, the external access point manages the other communication apparatus and the identification information in association with each other.

2. The communication apparatus according to claim 1, further comprising a notification unit configured to, in a case where the establishment unit establishes a connection with the other communication apparatus, notify the external access point of connection information indicating that the connection with the other communication apparatus is established.

3. The communication apparatus according to claim 2, further comprising a disconnection unit configured to disconnect a connection between the other communication apparatus and the communication apparatus,
wherein, in a case where the disconnection unit disconnects a connection with the other communication apparatus, the notification unit notifies the external access point of disconnection information indicating that the connection is disconnected.

4. The communication apparatus according to claim 3, wherein the sharing unit shares the identification information for identifying the other communication apparatus via a server with the external access point.

5. The communication apparatus according to claim 4, further comprising a reception unit configured to receive identification information assigned to a predetermined other communication apparatus by the external access point,
wherein, based on reception of the identification information for identifying the predetermined other communication apparatus by the reception unit, the assignment unit assigns the received identification information for identifying the predetermined other communication apparatus to the predetermined other communication apparatus.

6. The communication apparatus according to claim 5, further comprising a cancellation unit configured to, in a case where the reception unit receives the disconnection information indicating that the external access point has disconnected a connection with the predetermined other communication apparatus and a connection with the predetermined other communication apparatus has not been established by the communication apparatus, cancel the assignment of the identification information assigned to the predetermined other communication apparatus.

7. The communication apparatus according to claim 6, further comprising a request unit configured to request the identification information regarding the other communication apparatus from the external access point,
wherein the reception unit further receives a response to the request from the external access point.

8. The communication apparatus according to claim 7, wherein, in a case where the establishment unit establishes a connection with the other communication apparatus, the request unit makes the request to an external access point that has already established a connection with the other communication apparatus.

9. The communication apparatus according to claim 1, wherein the identification information for identifying the other communication apparatus is an association identifier (AID).

10. A control method for controlling a communication apparatus, the control method comprising:
establishing a connection with another communication apparatus;
assigning identification information for identifying the other communication apparatus to the other communication apparatus with which the connection is established; and
sharing the identification information with an external access point.

11. A non-transitory computer-readable storage medium storing instructions that, when executed by a computer, cause the computer to perform a control method for controlling a communication apparatus, the control method comprising:
establishing a connection with another communication apparatus;
assigning identification information for identifying the other communication apparatus to the other communication apparatus with which the connection is established; and
sharing the identification information with an external access point.
